(19) United States
(12) Patent Application Publication
(10) Pub. No.: US 2004/0250143 A1
(43) Pub. Date: Dec. 9, 2004

(54) Microcomputer having power supply circuit switching low pass filter

(75) Inventor: Michiaki Kuroiwa, Hyogo (JP)

Correspondence Address: BURNS DOANE SWECKER & MATHIS L L P, POST OFFICE BOX 1404, ALEXANDRIA, VA, 22313-1404, US

(73) Assignee: Renesas Technology Corp., Chiyoda-ku (JP)

(21) Appl. No.: 10/786,588

(22) Filed: Feb. 26, 2004

(30) Foreign Application Priority Data
Jun. 6, 2003 (JP) 2003-162517

(51) Int. Cl. G06F 1/26

(52) U.S. Cl. 713/300

(57) ABSTRACT

In a flash memory write mode, a microcomputer operation mode setting circuit sets a mode setting signal at one level. At this stage, a voltage drop caused by an LPF formed of a resistor, an inductor, and a capacitor can be suppressed at a low level. In a mode other than the flash memory write mode, the microcomputer operation mode setting circuit sets the mode setting signal at another level. At this stage, high frequency noise can be removed by the LPF formed of the resistor, the inductor, and the capacitor.

### BACKGROUND OF THE INVENTION

1. Field of the Invention

The present invention relates to a microcomputer, and in particular to a microcomputer having a power supply circuit with a low pass filter incorporated therein.

2. Description of the Background Art

In conventional microcomputers, some can suppress high frequency noise caused from a power supply terminal by incorporating a low pass filter (hereinafter, referred to as an LPF) in a power supply circuit.

A power supply circuit (a DC/DC converter circuit) described in Japanese Patent Laying-Open No. 9-93913 includes a converter boosting DC (direct current) voltage applied to an input terminal, a low impedance circuit switching an internal switch in accordance with an alternating current component of an output voltage from the converter, and a noise removing capacitor passing an alternating current component of an output signal output from the low impedance circuit to a ground surface.

The power supply circuit described in the foregoing reference can remove harmonic noise included in the alternating current component of the output voltage from the converter by means of the low impedance circuit and the noise removing capacitor, using the principle of an LPF. However, the power supply circuit has had a problem that a circuit connected to an output terminal is subject to a voltage drop caused by the LPF during high speed operation or low voltage operation.

### SUMMARY OF THE INVENTION

An object of the present invention is to provide a microcomputer having a power supply circuit capable of obviating an effect of a voltage drop caused by an LPF even during high speed operation or low voltage operation.

A microcomputer in accordance with the present invention includes a microcomputer unit, and a power supply circuit controlling power supply voltage for the microcomputer unit. The power supply circuit includes a power supply input terminal to which external power supply voltage is applied, a low pass filter provided between the power supply input terminal and the microcomputer unit, a switch element connected in parallel with the low pass filter between the power supply input terminal and the microcomputer unit, and a control circuit controlling on and off of the switch element.

According to the present invention, an effect of a voltage drop caused by an LPF can be obviated even during high speed operation or low voltage operation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a circuit configuration of a microcomputer in accordance with a first embodiment of the present invention.

FIG. 2 is a circuit diagram showing a circuit configuration of a microcomputer in accordance with a second embodiment of the present invention.

FIG. 3 is a circuit diagram showing a circuit configuration of a microcomputer in accordance with a third embodiment of the present invention.

FIG. 4 is a circuit diagram showing a circuit configuration of a microcomputer in accordance with a fourth embodiment of the present invention.

FIG. 5 is a circuit diagram showing a circuit configuration of a microcomputer in accordance with a fifth embodiment of the present invention.

FIG. 6 is a timing chart to explain a change in a clock signal CLK in response to a register signal Sreg.

### DESCRIPTION OF THE PREFERRED EMBODIMENTS

In the following, embodiments of the present invention will be described in detail with reference to the drawings. It is to be noted that an identical or corresponding element in the drawings will be identified by an identical reference character, and description thereof will not be repeated.

First Embodiment

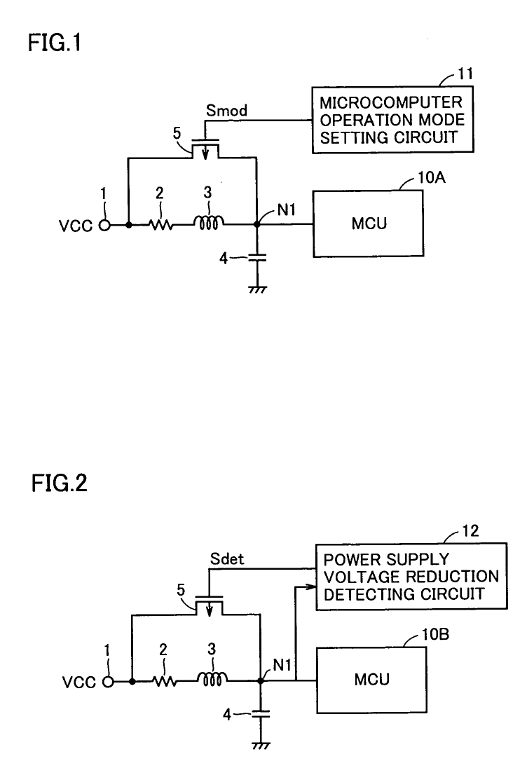

FIG. 1 is a circuit diagram showing a circuit configuration of a microcomputer in accordance with a first embodiment of the present invention.

A microcomputer of the first embodiment shown in FIG. 1 includes a power supply input terminal 1 to which external power supply voltage VCC is applied, a resistor 2 representing a resistance component between power supply input terminal 1 and a node N1, an inductor 3 representing an inductance component between power supply input terminal 1 and node N1, and a capacitor 4 connected between node N1 and a ground node.

Resistor 2, inductor 3, and capacitor 4 constitute an LPF. It is to be noted that resistor 2, inductor 3, and capacitor 4 include a resistance component, an inductance component, and a capacitance component, respectively, generated parasitically by the routed power supply line.

The microcomputer of the first embodiment shown in FIG. 1 further includes a P-channel MOS transistor 5 connected in parallel with resistor 2 and inductor 3 between power supply input terminal 1 and node N1, a microcomputer unit (MCU) 10A connected to node N1, and a microcomputer operation mode setting circuit 11 outputting a mode setting signal Smod to a gate of P-channel MOS transistor 5. It is to be noted that P-channel MOS transistor 5 may be any switching element that is turned on or off in response to mode setting signal Smod, and it is not limited to only a P-channel MOS transistor.

Power supply input terminal 1, resistor 2, inductor 3, capacitor 4, P-channel MOS transistor 5, and microcomputer operation mode setting circuit 11 constitute a power supply circuit of the microcomputer in accordance with the first embodiment, controlling power supply voltage applied to node N1 for MCU 10A. MCU 10A includes a CPU (Central Processing Unit), a flash memory, a RAM (Random Access Memory), and a peripheral circuit.

In a flash memory write mode in which write operation is performed to the flash memory included in MCU 10A, microcomputer operation mode setting circuit 11 sets mode setting signal Smod at an L level (logical low). In a mode other than the flash memory write mode, microcomputer operation mode setting circuit 11 sets mode setting signal Smod at an H level (logical high).

When mode setting signal Smod is at an L level, P-channel MOS transistor 5 is turned on. Thus, a short circuit occurs between power supply input terminal 1 and node N1, reducing impedance between power supply input terminal 1 and node N1. Thereby, a voltage drop caused by the LPF formed of resistor 2, inductor 3, and capacitor 4 can be suppressed at a low level.

Therefore, when mode setting signal Smod is at an L level, external power supply voltage VCC applied to power supply input terminal 1 is supplied to MCU 10A without being affected by the voltage drop caused by the LPF. Thus, even when external power supply voltage VCC applied to power supply input terminal 1 is low, minimum operating voltage required during the flash memory write mode can be supplied to MCU 10A.

On the other hand, when mode setting signal Smod is at an H level, P-channel MOS transistor 5 is turned off. At this stage, the microcomputer is in a state equivalent to P-channel MOS transistor 5 being absent. Accordingly, when noise is applied to power supply input terminal 1, high frequency noise is removed by the LPF formed of resistor 2, inductor 3, and capacitor 4. Thus, fluctuations in the voltage supplied to MCU 10A can be suppressed, preventing a malfunction of MCU 10A.

Further, also when noise is caused from MCU 10A due to the operation of MCU 10A, high frequency noise is removed by the LPF formed of resistor 2, inductor 3, and capacitor 4. Thus, emission of the high frequency noise from power supply input terminal 1 can be suppressed.

By setting the level of mode setting signal Smod depending on whether or not the microcomputer is in the flash memory write mode according to the first embodiment as described above, low voltage characteristic of MCU 10A in the flash memory write mode can be improved, and an effect due to high frequency noise in a mode other than the flash memory write mode can be prevented.

Second Embodiment

FIG. 2 is a circuit diagram showing a circuit configuration of a microcomputer in accordance with a second embodiment of the present invention.

The microcomputer of the second embodiment shown in FIG. 2 has a structure in which MCU 10A and microcomputer operation mode setting circuit 11 of the first embodiment are replaced with an MCU 10B and a power supply voltage reduction detecting circuit 12, respectively. Since power supply input terminal 1, resistor 2, inductor 3, capacitor 4, and P-channel MOS transistor 5 are identical to those in the first embodiment, description thereof will not be repeated here.

Power supply input terminal 1, resistor 2, inductor 3, capacitor 4, P-channel MOS transistor 5, and power supply voltage reduction detecting circuit 12 constitute a power supply circuit of the microcomputer in accordance with the second embodiment, controlling power supply voltage applied to node N1 for MCU 10B. MCU 10B includes a CPU, a flash memory, a RAM, and a peripheral circuit. The flash memory may be replaced with another programmable ROM (Read Only Memory) or mask ROM.

Power supply voltage reduction detecting circuit 12 outputs a power supply voltage reduction detecting signal Sdet to a gate of P-channel MOS transistor 5. Power supply voltage reduction detecting circuit 12 monitors the power supply voltage applied to node N1 for MCU 10B. When the power supply voltage for MCU 10B becomes lower than a predetermined voltage, power supply voltage reduction detecting circuit 12 sets power supply voltage reduction detecting signal Sdet at an L level. When the power supply voltage for MCU 10B becomes not less than the predetermined voltage, power supply voltage reduction detecting circuit 12 sets power supply voltage reduction detecting signal Sdet at an H level.

When power supply voltage reduction detecting signal Sdet is at an L level, P-channel MOS transistor 5 is turned on. Thus, a short circuit occurs between power supply input terminal 1 and node N1, reducing impedance between power supply input terminal 1 and node N1. Thereby, a voltage drop caused by the LPF formed of resistor 2, inductor 3, and capacitor 4 can be suppressed at a low level.

Therefore, when power supply voltage reduction detecting signal Sdet is at an L level, external power supply voltage VCC applied to power supply input terminal 1 is supplied to MCU 10B without being affected by the voltage drop caused by the LPF. Thus, the power supply voltage applied to node N1 for MCU 10B increases by the suppressed amount of the voltage drop caused by the LPF, ensuring normal operating voltage for MCU 10B.

When the power supply voltage for MCU 10B becomes lower than the predetermined voltage, operating current for MCU 10B is decreased. Thus, driving capability of a transistor included in MCU 10B is reduced, improving the resistance of MCU 10B to malfunction when noise is applied to power supply input terminal 1. Further, in accordance with the decrease in the operating current for MCU 10B, noise caused from MCU 10B is also held at a low level. Accordingly, even when power supply voltage reduction detecting signal Sdet is at an L level, low voltage characteristic of MCU 10B and its resistance to high frequency noise do not have to be taken into consideration.

On the other hand, when power supply voltage reduction detecting signal Sdet is at an H level, P-channel MOS transistor 5 is turned off. At this stage, the microcomputer is in a state equivalent to P-channel MOS transistor 5 being absent. Accordingly, when noise is applied to power supply input terminal 1, high frequency noise is removed by the LPF formed of resistor 2, inductor 3, and capacitor 4. Thus, fluctuations in the voltage supplied to MCU 10B can be suppressed, preventing a malfunction of MCU 10B.

Further, also when noise is caused from MCU 10B due to the operation of MCU 10B, high frequency noise is removed by the LPF formed of resistor 2, inductor 3, and capacitor 4. Thus, emission of the high frequency noise from power supply input terminal 1 can be suppressed.

By setting the level of power supply voltage reduction detecting signal Sdet depending on whether or not the power supply voltage for MCU 10B is lower than the predetermined voltage according to the second embodiment as described above, the normal operating voltage for MCU 10B can be ensured even when the power supply voltage for MCU 10B becomes lower than the predetermined voltage. Further, an effect caused by high frequency noise can be prevented.

Third Embodiment

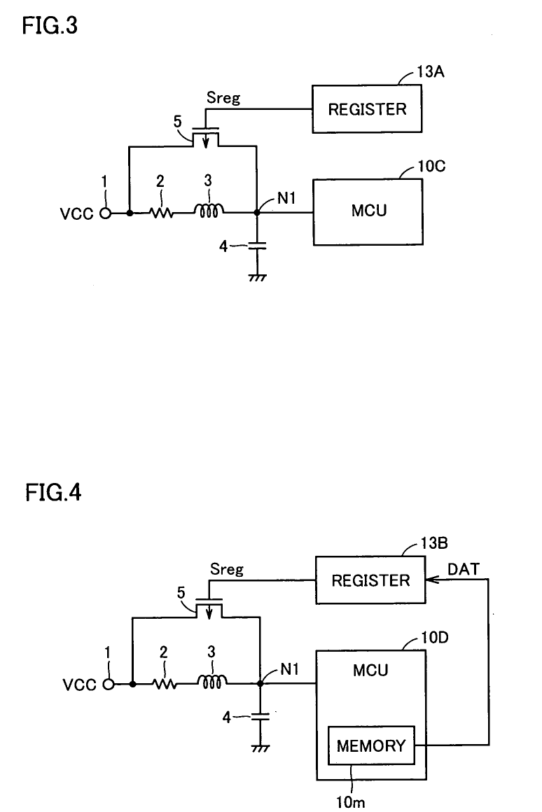

FIG. 3 is a circuit diagram showing a circuit configuration of a microcomputer in accordance with a third embodiment of the present invention.

The microcomputer of the third embodiment shown in FIG. 3 has a structure in which MCU 10A and microcomputer operation mode setting circuit 11 of the first embodiment are replaced with an MCU 10C and a register 13A, respectively. Since power supply input terminal 1, resistor 2, inductor 3, capacitor 4, and P-channel MOS transistor 5 are identical to those in the first embodiment, description thereof will not be repeated here.

Power supply input terminal 1, resistor 2, inductor 3, capacitor 4, P-channel MOS transistor 5, and register 13A constitute a power supply circuit of the microcomputer in accordance with the third embodiment, controlling power supply voltage applied to node N1 for MCU 10C. MCU 10C includes a CPU, a flash memory, a RAM, and a peripheral circuit. The flash memory may be replaced with another programmable ROM or mask ROM.

Register 13A outputs a register signal Sreg to a gate of P-channel MOS transistor 5. Register 13A is a programmable register, and holds a value “0” or “1” depending on a condition of the power supply voltage supplied to MCU 10C. When register 13A holds a value “0”, register signal Sreg attains an L level. When register 13A holds a value “1”, register signal Sreg attains an H level.

When register signal Sreg is at an L level, P-channel MOS transistor 5 is turned on. Thus, a short circuit occurs between power supply input terminal 1 and node N1, reducing impedance between power supply input terminal 1 and node N1. Thereby, a voltage drop caused by the LPF formed of resistor 2, inductor 3, and capacitor 4 can be suppressed at a low level.

Therefore, when register signal Sreg is at an L level, external power supply voltage VCC applied to power supply input terminal 1 is supplied to MCU 10C without being affected by the voltage drop caused by the LPF. Thus, even when external power supply voltage VCC applied to power supply input terminal 1 is low, normal operating voltage for MCU 10C can be supplied to MCU 10C.

On the other hand, when register signal Sreg is at an H level, P-channel MOS transistor 5 is turned off. At this stage, the microcomputer is in a state equivalent to P-channel MOS transistor 5 being absent. Accordingly, when noise is applied to power supply input terminal 1, high frequency noise is removed by the LPF formed of resistor 2, inductor 3, and capacitor 4. Thus, fluctuations in the voltage supplied to MCU 10C can be suppressed, preventing a malfunction of MCU 10C.

Further, also when noise is caused from MCU 10C due to the operation of MCU 10C, high frequency noise is removed by the LPF formed of resistor 2, inductor 3, and capacitor 4. Thus, emission of the high frequency noise from power supply input terminal 1 can be suppressed.

By setting the level of register signal Sreg depending on the condition of the power supply voltage supplied to MCU 10C according to the third embodiment as described above, whether to place importance on the improvement of low voltage characteristic of MCU 10C or on the prevention of an effect caused by high frequency noise can be selected arbitrarily.

Fourth Embodiment

FIG. 4 is a circuit diagram showing a circuit configuration of a microcomputer in accordance with a fourth embodiment of the present invention.

The microcomputer of the fourth embodiment shown in FIG. 4 has a structure in which MCU 10A and microcomputer operation mode setting circuit 11 of the first embodiment are replaced with an MCU 10D and a register 13B, respectively. Since power supply input terminal 1, resistor 2, inductor 3, capacitor 4, and P-channel MOS transistor 5 are identical to those in the first embodiment, description thereof will not be repeated here.

Power supply input terminal 1, resistor 2, inductor 3, capacitor 4, P-channel MOS transistor 5, and register 13B constitute a power supply circuit of the microcomputer in accordance with the fourth embodiment, controlling power supply voltage applied to node N1 for MCU 10D. MCU 10D includes a CPU, a RAM, a peripheral circuit, and a memory 10m.

In a state of a reset sequence of MCU 10D, memory 10m transfers a data signal DAT at a specific address having a value “0” or “1”, to register 13B. The value of data signal DAT is determined depending on a condition of the power supply voltage supplied to MCU 10D. Register 13B latches and retains data signal DAT output from memory 10m. Operations of memory 10m and register 13B in the state of the reset sequence of MCU 10D are controlled by the CPU in MCU 10D.

Register 13B outputs register signal Sreg to a gate of P-channel MOS transistor 5. When the reset sequence of MCU 10D is initiated and data signal DAT output from memory 10m exhibits the value of “0”, register signal Sreg attains an L level. When the reset sequence of MCU 10D is initiated and data signal DAT output from memory 10m exhibits the value of “1”, register signal Sreg attains an H level.

When register signal Sreg is at an L level, P-channel MOS transistor 5 is turned on. Thus, a short circuit occurs between power supply input terminal 1 and node N1, reducing impedance between power supply input terminal 1 and node N1. Thereby, a voltage drop caused by the LPF formed of resistor 2, inductor 3, and capacitor 4 can be suppressed at a low level.

Therefore, when register signal Sreg is at an L level, external power supply voltage VCC applied to power supply input terminal 1 is supplied to MCU 10D without being affected by the voltage drop caused by the LPF. Thus, even when external power supply voltage VCC applied to power supply input terminal 1 is low, normal operating voltage for MCU 10D can be supplied to MCU 10D.

On the other hand, when register signal Sreg is at an H level, P-channel MOS transistor 5 is turned off. At this stage, the microcomputer is in a state equivalent to P-channel MOS transistor 5 being absent. Accordingly, when noise is applied to power supply input terminal 1, high frequency noise is removed by the LPF formed of resistor 2, inductor 3, and capacitor 4. Thus, fluctuations in the voltage supplied to MCU 10D can be suppressed, preventing a malfunction of MCU 10D.

Further, also when noise is caused from MCU 10D due to the operation of MCU 10D, high frequency noise is removed by the LPF formed of resistor 2, inductor 3, and capacitor 4. Thus, emission of the high frequency noise from power supply input terminal 1 can be suppressed.

As described above, according to the fourth embodiment, an effect equal to that of the third embodiment can be obtained just by storing data at a specific address of memory 10m, without setting register 13B by a program.

Fifth Embodiment

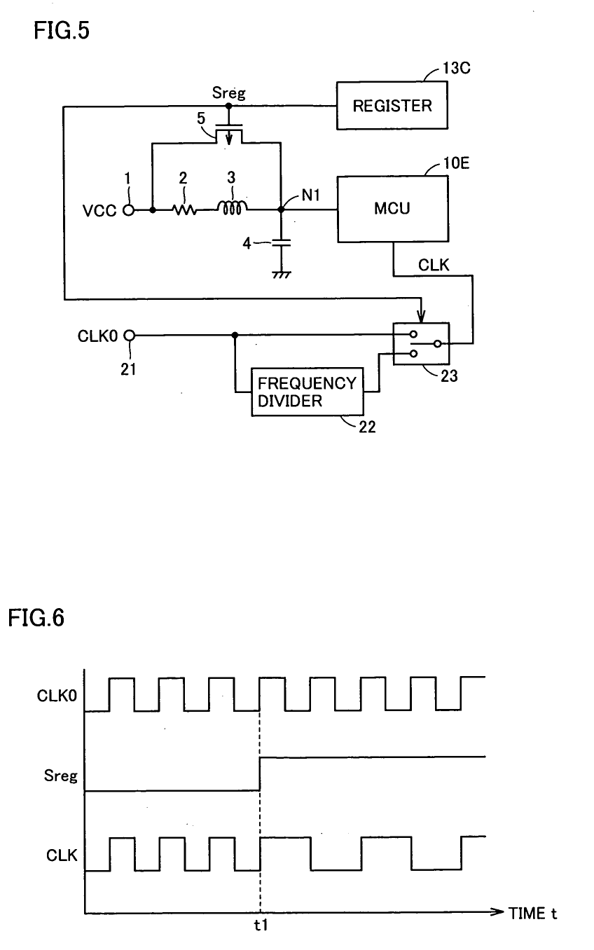

FIG. 5 is a circuit diagram showing a circuit configuration of a microcomputer in accordance with a fifth embodiment of the present invention.

The microcomputer of the fifth embodiment shown in FIG. 5 has a structure in which MCU 10A and microcomputer operation mode setting circuit 11 of the first embodiment are replaced with an MCU 10E and a register 13C, respectively. The microcomputer of the fifth embodiment further includes a clock input terminal 21 to which an external clock signal CLK0 is input, a frequency divider 22 dividing a frequency of external clock signal CLK0 by two, and a selector 23 which selects either one of an external clock signal having a frequency divided by two and an external clock signal not subjected to the frequency division by two, and outputs the selected clock signal to MCU 10E as a clock signal CLK. Since power supply input terminal 1, resistor 2, inductor 3, capacitor 4, and P-channel MOS transistor 5 are identical to those in the first embodiment, description thereof will not be repeated here.

Power supply input terminal 1, resistor 2, inductor 3, capacitor 4, P-channel MOS transistor 5, and register 13C constitute a power supply circuit of the microcomputer in accordance with the fifth embodiment, controlling power supply voltage applied to node N1 for MCU 10E. MCU 10E includes a CPU, a flash memory, a RAM, and a peripheral circuit. The flash memory may be replaced with another programmable ROM or mask ROM.

Register 13C outputs register signal Sreg to a gate of P-channel MOS transistor 5 and to selector 23. Register 13C is a programmable register, and holds a value “0” or “1” depending on a condition of the power supply voltage supplied to MCU 10E. When register 13C holds a value “0”, register signal Sreg attains an L level. When register 13C holds a value “1”, register signal Sreg attains an H level.

When register signal Sreg is at an L level, P-channel MOS transistor 5 is turned on. Thus, a short circuit occurs between power supply input terminal 1 and node N1, reducing impedance between power supply input terminal 1 and node N1. Thereby, a voltage drop caused by the LPF formed of resistor 2, inductor 3, and capacitor 4 can be suppressed at a low level.

Therefore, when register signal Sreg is at an L level, external power supply voltage VCC applied to power supply input terminal 1 is supplied to MCU 10E without being affected by the voltage drop caused by the LPF. Thus, even when external power supply voltage VCC applied to power supply input terminal 1 is low, normal operating voltage for MCU 10E can be supplied to MCU 10E.

On the other hand, when register signal Sreg is at an H level, P-channel MOS transistor 5 is turned off. At this stage, the microcomputer is in a state equivalent to P-channel MOS transistor 5 being absent. Accordingly, when noise is applied to power supply input terminal 1, high frequency noise is removed by the LPF formed of resistor 2, inductor 3, and capacitor 4. Thus, fluctuations in the voltage supplied to MCU 10E can be suppressed, preventing a malfunction of MCU 10E.

Further, also when noise is caused from MCU 10E due to the operation of MCU 10E, high frequency noise is removed by the LPF formed of resistor 2, inductor 3, and capacitor 4. Thus, emission of the high frequency noise from power supply input terminal 1 can be suppressed.

Register signal Sreg is also output to selector 23. Selector 23 selects either one of the external clock signal having the frequency divided by two and the external dock signal not subjected to the frequency division by two, in response to register signal Sreg, and outputs the selected clock signal to MCU 10E as clock signal CLK.

FIG. 6 is a timing chart to explain the change in clock signal CLK in response to register signal Sreg.

As shown in FIG. 6, register signal Sreg attains an L level before time t1. At this stage, clock signal CLK is identical to external clock signal CLK0, as shown in FIG. 6. On the other hand, register signal Sreg attains an H level on and after time t1. At this stage, clock signal CLK has a frequency half that of external clock signal CLK0, as shown in FIG. 6.

With reference to FIG. 5, when register signal Sreg is at an L level, selector 23 selects and supplies to MCU 10E external clock signal CLK0 as clock signal CLK. On the other hand, when register signal Sreg is at an H level, selector 23 selects the external clock signal having the frequency divided by two by frequency divider 22, and supplies it to MCU 10E as clock signal CLK.

When register signal Sreg is at an H level, the external clock signal having the frequency divided by two is supplied to MCU 10E. As a result, power consumption in MCU 10E can be reduced.

On the other hand, when register signal Sreg is at an L level, the external clock signal not subjected to the frequency division by two is supplied to MCU 10E. As a result, power consumption in MCU 10E increases, compared to the case where the external clock signal having the frequency divided by two is supplied to MCU 10E.

However, when register signal Sreg is at an L level, external power supply voltage VCC applied to power supply input terminal 1 is supplied to MCU 10E without being affected by the voltage drop caused by the LPF, as described before. Thus, relative increase in the power consumption in MCU 10E can be suppressed.

By selecting a clock signal supplied to MCU 10E in response to register signal Sreg according to the fifth embodiment as described above, the relative increase in the power consumption in MCU 10E can be suppressed, in addition to the effect of the third embodiment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A microcomputer, comprising:
a microcomputer unit; and
a power supply circuit controlling power supply voltage for said microcomputer unit,
said power supply circuit including
a power supply input terminal to which external power supply voltage is applied,
a low pass filter provided between said power supply input terminal and said microcomputer unit,
a switch element connected in parallel with said low pass filter, between said power supply input terminal and said microcomputer unit, and
a control circuit controlling on and off of said switch element.

2. The microcomputer according to claim 1, wherein said control circuit controls on and off of said switch element depending on whether or not a flash memory included in said microcomputer unit is being written.

3. The microcomputer according to claim 1, wherein said control circuit controls on and off of said switch element depending on whether or not said power supply voltage is lower than a predetermined voltage.

4. The microcomputer according to claim 1, wherein said control circuit is a register holding on-off information of said switching element.

5. The microcomputer according to claim 4, further comprising:
a clock input terminal to which an external clock signal is input;
a frequency divider dividing a frequency of said external clock signal by two; and
a selector selecting either one of an external clock signal having a frequency divided by two by said frequency divider and an external clock signal not subjected to frequency division by two depending on the on-off information of said switch element held by said register, and supplying it to said microcomputer unit.

6. The microcomputer according to claim 1, wherein said control circuit is a register controlling on and off of said switch element in response to a data signal from a memory included in said microcomputer unit.
